(19) United States
(12) Patent Application Publication
(10) Pub. No.: US 2025/0102944 A1
(43) Pub. Date: Mar. 27, 2025

(54) IMAGE FORMING APPARATUS

(71) Applicant: FUJIFILM Business Innovation Corp., Tokyo (JP)

(72) Inventor: Satoshi EZAWA, Kanagawa (JP)

(73) Assignee: FUJIFILM Business Innovation Corp., Tokyo (JP)

(21) Appl. No.: 18/586,537

(22) Filed: Feb. 26, 2024

(30) Foreign Application Priority Data
Sep. 26, 2023 (JP) 2023-163221

(51) Int. Cl. G03G 15/01; G03G 15/00

(52) U.S. Cl. CPC G03G 15/0189; G03G 15/5008; G03G 15/505; G03G 2215/1623

(57) ABSTRACT

An image forming apparatus includes: a formation body on which a latent image is developed so that an image is formed; a transfer belt with an outer peripheral surface onto which the image formed on the formation body is transferred, the transfer belt having an annular shape; a driving roll around which the transfer belt is wound and that causes the transfer belt to revolve; a transfer body that transfers, at a transfer region between the transfer body and the transfer belt, the image from the transfer belt to a recording medium while transporting the recording medium; a drive mechanism that rotationally drives the transfer body; a detection unit that detects a predetermined rotation position of the transfer body; a writing unit that writes the latent image on the formation body based on a detection timing at which the detection unit detects the rotation position; and a speed adjustment mechanism that adjusts a rotation speed of the transfer body rotated by the drive mechanism each time the transfer body makes one rotation, that switches between a first adjustment pattern and a second adjustment pattern in which a speed profile is different from the first adjustment pattern each time the transfer body makes one rotation, and that synchronizes a switching timing, at which switching between the adjustment patterns is performed, with the detection timing.

### CROSS-REFERENCE TO RELATED APPLICATIONS

This application is based on and claims priority under 35 USC 119 from Japanese Patent Application No. 2023-163221 filed Sep. 26, 2023.

### BACKGROUND

### (i) Technical Field

The present invention relates to an image forming apparatus.

### (ii) Related Art

Disclosed in JP2012-220812A is a transfer device including: a belt-shaped image carrier that carries an image; a driving roller around which the image carrier carrying the image is wound and that moves the image carrier; a first tension roller around which the image carrier moved by the driving roller is wound and that applies a tensile force to the image carrier; a first elastic support portion that includes a first elastic member generating the tensile force and that supports one side of a rotary shaft of the first tension roller; a second elastic support portion that includes a second elastic member generating the tensile force and that supports the other side of the rotary shaft of the first tension roller, a backup roller around which the image carrier wound around the tension roller is wound; a transfer roller that is provided with a recess portion at a peripheral surface and that abuts onto the image carrier wound around the backup roller to form a transfer nip; and a second tension roller around which the image carrier wound around the backup roller is wound and that applies a tensile force to the image carrier.

### SUMMARY

As an image forming apparatus, an image forming apparatus is conceivable which includes: a formation body on which a latent image is developed so that an image is formed; a transfer belt with an outer peripheral surface onto which the image formed on the formation body is transferred, the transfer belt having an annular shape; a driving roll around which the transfer belt is wound and that causes the transfer belt to revolve; a transfer body that transfers, at a transfer region between the transfer body and the transfer belt, the image from the transfer belt to a recording medium while transporting the recording medium; a drive mechanism that rotationally drives the transfer body; a detection unit that detects a predetermined rotation position of the transfer body; a writing unit that writes the latent image on the formation body based on a detection timing at which the detection unit detects the rotation position; and a speed adjustment mechanism that adjusts the rotation speed of the transfer body rotated by the drive mechanism each time the transfer body makes one rotation, that switches between a first adjustment pattern and a second adjustment pattern different from the first adjustment pattern each time the transfer body makes one rotation.

Here, in a case where the speed adjustment mechanism in the image forming apparatus switches between the first adjustment pattern and the second adjustment pattern regardless of the detection timing at which the detection unit detects the rotation position, a writing timing at which the writing unit performs writing may vary and a transfer position where an image is transferred onto the recording medium may vary since the speed profiles of the first adjustment pattern and the second adjustment pattern are different from each other.

Aspects of non-limiting embodiments of the present disclosure relate to an image forming apparatus that suppresses a variation in transfer position where an image is transferred onto the recording medium in comparison with a case where the speed adjustment mechanism switches between the first adjustment pattern and the second adjustment pattern regardless of the detection timing at which the detection unit detects the rotation position.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a formation body on which a latent image is developed so that an image is formed; a transfer belt with an outer peripheral surface onto which the image formed on the formation body is transferred, the transfer belt having an annular shape; a driving roll around which the transfer belt is wound and that causes the transfer belt to revolve; a transfer body that transfers, at a transfer region between the transfer body and the transfer belt, the image from the transfer belt to a recording medium while transporting the recording medium; a drive mechanism that rotationally drives the transfer body; a detection unit that detects a predetermined rotation position of the transfer body; a writing unit that writes the latent image on the formation body based on a detection timing at which the detection unit detects the rotation position; and a speed adjustment mechanism that adjusts a rotation speed of the transfer body rotated by the drive mechanism each time the transfer body makes one rotation, that switches between a first adjustment pattern and a second adjustment pattern in which a speed profile is different from the first adjustment pattern each time the transfer body makes one rotation, and that synchronizes a switching timing, at which switching between the adjustment patterns is performed, with the detection timing.

### BRIEF DESCRIPTION OF THE DRAWINGS

Exemplary embodiment(s) of the present invention will be described in detail based on the following figures, wherein:

FIG. 1 is a schematic view showing an image forming apparatus according to the present exemplary embodiment;

FIG. 2 is a perspective view showing a configuration around a transfer cylinder according to the present exemplary embodiment;

FIG. 3 is a perspective view showing a configuration around a fixation cylinder according to the present exemplary embodiment;

FIG. 4 is a perspective view showing a configuration around a pair of sprockets according to the present exemplary embodiment;

FIG. 5 is a perspective view showing grippers according to the present exemplary embodiment;

FIG. 6 is a block diagram showing a hardware configuration of a control device according to the present exemplary embodiment;

FIG. 7 is a block diagram showing an example of a functional configuration of the control device according to the present exemplary embodiment; and

FIG. 8 is a diagram showing a first adjustment pattern and a second adjustment pattern according to the present exemplary embodiment.

### DETAILED DESCRIPTION

An example of an exemplary embodiment of the present invention will be described below with reference to the drawings.

### Image Forming Apparatus 10

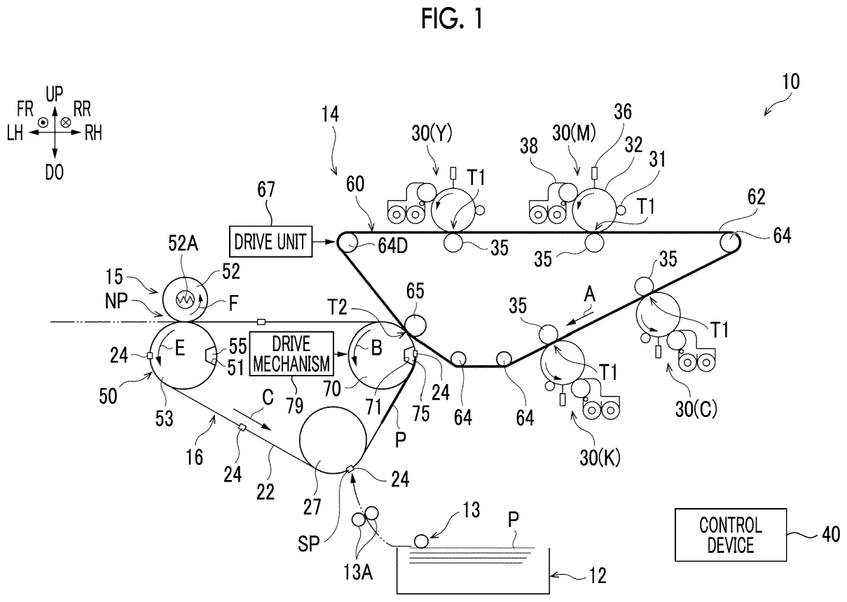

First, a configuration of an image forming apparatus 10 according to the present exemplary embodiment will be described. FIG. 1 is a schematic view showing the configuration of the image forming apparatus 10 according to the present exemplary embodiment.

Note that an arrow UP shown in the drawing represents a direction to an upper side (an upper side in a vertical direction) of the apparatus, and an arrow DO represents a direction to a lower side of the apparatus (a lower side in the vertical direction). In addition, an arrow LH shown in the drawing represents a direction to a left side of the apparatus and an arrow RH represents a direction to a right side of the apparatus. In addition, an arrow FR shown in the drawing represents a direction to a front side of the apparatus and an arrow RR represents a direction to a rear side of the apparatus. Since these directions are directions determined for the sake of convenience of description, the configuration of the apparatus is not limited by these directions. Note that regarding each of the directions related to the apparatus, the term “apparatus” may be omitted. That is, for example, “the upper side of the apparatus” may simply be described as “the upper side”. In addition, a front-rear direction corresponds to an axial direction of a sprocket 75 which will be described later and furthermore, the front-rear direction may be referred to as a lateral direction or a horizontal direction. In addition, an up-down direction, a right-left direction, and the front-rear direction are directions that intersect each other (specifically, directions orthogonal to each other).

In addition, a symbol in which “x” is in “o” in the drawings means an arrow from the front to the back of the paper surface. In addition, a symbol in which “.” is in “o” in the drawings means an arrow from the back to the front of the paper surface.

The image forming apparatus 10 shown in FIG. 1 is an electrophotographic image forming apparatus that forms a toner image (an example of an image) on a recording medium P. Specifically, the image forming apparatus 10 includes a medium accommodation portion 12, a feeding unit 13, an image forming unit 14, a transport mechanism 16, a first rotation position sensor 91, a second rotation position sensor 92, and a control device 40. Hereinafter, each part (the medium accommodation portion 12, the feeding unit 13, the image forming unit 14, the transport mechanism 16, the first rotation position sensor 91, the second rotation position sensor 92, and the control device 40) of the image forming apparatus 10 will be described.

### Medium Accommodation Portion 12

The medium accommodation portion 12 is a constituent unit that accommodates the recording medium P in the image forming apparatus 10. The recording medium P accommodated in the medium accommodation portion 12 is fed to the transport mechanism 16 by the feeding unit 13.

As the recording medium P, for example, a paper sheet is used. The recording medium P is not limited to a paper sheet and the recording medium P may be, for example, a film or the like as long as the recording medium P is a medium on which an image can be formed.

### Feeding Unit 13

The feeding unit 13 is a constituent unit that feeds the recording medium P accommodated in the medium accommodation portion 12. Specifically, the feeding unit 13 includes a feeding member 13A that feeds the recording medium P toward grippers 24 (which will be described later) of the transport mechanism 16 at a predetermined feeding timing.

The feeding member 13A is composed of, for example, transport rollers (so-called registration rollers) or the like that transport the recording medium P fed from the medium accommodation portion 12 at the predetermined feeding timing.

### Image Forming Unit 14

The image forming unit 14 shown in FIG. 1 is a constituent unit that forms an image on the recording medium P. Specifically, as shown in FIG. 1, the image forming unit 14 includes toner image forming units 30, a transfer device 60, and a fixing device 15.

### Toner Image Forming Unit 30

The toner image forming units 30 shown in FIG. 1 are constituent units that form toner images. A plurality of the toner image forming units 30 are provided to form toner images of respective colors. In the present exemplary embodiment, the toner image forming units 30 for a total of four colors which are yellow (Y), magenta (M), cyan (C), and black (K) are provided. (Y), (M), (C), and (K) shown in FIG. 1 indicate constituent units corresponding to the respective colors.

Note that the toner image forming units 30 for the respective colors have the same configuration as each other except for a toner to be used. Therefore, in FIG. 1, each part of a toner image forming unit 30 (M), which serves as a representative of the toner image forming units 30 for the respective colors, is shown with a reference numeral given thereto.

Specifically, each of the toner image forming units 30 for the respective colors includes a photoreceptor 32 that rotates in one direction (for example, a counterclockwise direction in FIG. 1). In addition, each of the toner image forming units 30 for the respective colors includes a charger 31, an exposure device 36, and a developing device 38. The photoreceptor 32 is an example of a formation body. The exposure device 36 is an example of a writing unit.

In each of the toner image forming units 30 for the respective colors, the charger 31 charges the photoreceptor 32 (a charging step). Furthermore, the exposure device 36 causes the photoreceptor 32 charged by the charger 31 to be exposed to light so that an electrostatic latent image is formed on the photoreceptor 32 (an exposure step). Specifically, the exposure device 36 causes the photoreceptor 32 to be exposed to light at a predetermined writing timing so that the electrostatic latent image is written on the photoreceptor 32. In addition, the developing device 38 develops the electrostatic latent image, which is formed on the photoreceptor 32 by the exposure device 36, to form a toner image (a developing step).

In this manner, an electrostatic latent image is developed on the photoreceptor 32 so that a toner image is formed on the photoreceptor 32. The electrostatic latent image is an example of a latent image. The toner image is an example of an image.

In the present exemplary embodiment, in a case of forming toner images by means of a total of four colors which are yellow (Y), magenta (M), cyan (C), and black (K), each of the charging step, the exposure step, the developing step, and a primary transfer step (which will be described later) is performed in the order of a toner image forming unit 30 (Y), a toner image forming unit 30 (M), a toner image forming unit 30 (C), and a toner image forming unit 30 (K).

### Transfer Device 60

The transfer device 60 shown in FIG. 1 is a device that transfers, to the recording medium P, toner images formed by the toner image forming units 30 for the respective colors. Specifically, the transfer device 60 primarily transfers, to a transfer belt 62 which is an intermediate transfer body, toner images on the photoreceptors 32 for the respective colors such that the toner images are superimposed on each other and secondarily transfers, to the recording medium P, the superimposed toner images. As shown in FIG. 1, the transfer device 60 includes the transfer belt 62 having an annular shape, a plurality of primary transfer rolls 35, and a transfer cylinder 70. The transfer cylinder 70 is an example of a transfer body.

The primary transfer rolls 35 are rolls that are respectively provided at the toner image forming units 30 and that transfer, to the transfer belt 62, the toner images on the photoreceptors 32 for the respective colors at primary transfer regions T1 between the photoreceptors 32 and the primary transfer rolls 35. In the present exemplary embodiment, a primary transfer electric field is applied between the primary transfer rolls 35 and the photoreceptors 32, so that the toner images formed on the photoreceptors 32 are transferred to the transfer belt 62 at the primary transfer regions T1.

The toner images are transferred to an outer peripheral surface of the transfer belt 62 from the photoreceptors 32 for the respective colors. As shown in FIG. 1, the transfer belt 62 has an endless shape and is wound around a plurality of rolls 64 including a driving roll 64D and a facing roll 65 such that the transfer belt 62 has an approximately inverted triangular shape as seen in a front view. The transfer belt 62 is caused to revolve in a direction along an arrow A as the driving roll 64D is rotationally driven by a drive unit 67 composed of a drive motor or the like.

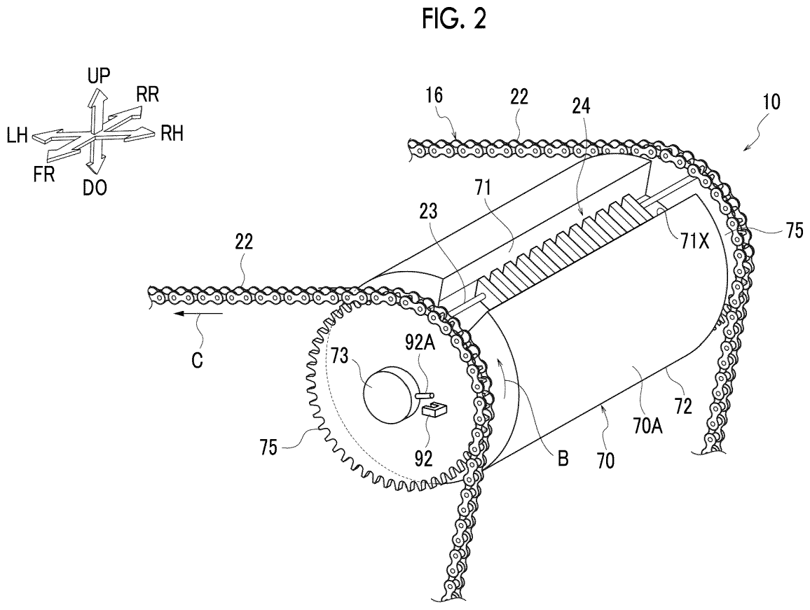

The transfer cylinder 70 has a function of transferring, to the recording medium P, the toner images transferred onto the transfer belt 62. As shown in FIGS. 1 and 2, a recess portion 71 is formed at an outer peripheral surface 70A of the transfer cylinder 70 (specifically, a cylinder body 72 which will be described later) and the transfer cylinder 70 rotates in a rotation direction B (a direction along an arrow B). The recess portion 71 is long in an axial direction of the transfer cylinder 70 and has a depth along a radial direction of the transfer cylinder 70.

As shown in FIG. 1, the transfer cylinder 70 is disposed diagonally below the transfer belt 62 while being disposed to the left to the transfer belt 62 such that the transfer cylinder 70 faces the transfer belt 62. Furthermore, the transfer cylinder 70 comes into contact with the transfer belt 62 in a range on the outer peripheral surface 70A from an upstream end to a downstream end in a rotation direction of the recess portion 71 and does not come into contact with the transfer belt 62 at the recess portion 71.

As shown in FIG. 2, a pair of sprockets 75 is provided on both of axial end sides of the transfer cylinder 70. Specifically, the transfer cylinder 70 is configured to include the cylinder body 72 having an approximately cylindrical shape and the pair of sprockets 75 provided on both of axial end sides with respect to the cylinder body 72. The pair of sprockets 75 is disposed to be coaxial with the cylinder body 72.

In the transfer device 60, a drive mechanism 79 (refer to FIG. 1) composed of a drive motor or the like rotationally drives the transfer cylinder 70. In the transfer cylinder 70, the cylinder body 72 and the pair of sprockets 75 integrally rotate with each other in the rotation direction B in a case where the cylinder body 72 rotates in the rotation direction B by being rotationally driven by the drive mechanism 79.

In the present exemplary embodiment, the transfer belt 62 and the transfer cylinder 70 (specifically, the cylinder body 72) transport the recording medium P transported by the transport mechanism 16 (specifically, grippers 24 which will be described later) by rotating in a state where the recording medium P is sandwiched between the transfer belt 62 and the transfer cylinder 70 at a secondary transfer region T2. Then, a secondary transfer electric field is applied between the facing roll 65 and the transfer cylinder 70, so that the transfer cylinder 70 transfers, to the recording medium P at the secondary transfer region T2, the toner images transferred onto the transfer belt 62. As described above, at the secondary transfer region T2 between the transfer cylinder 70 and the transfer belt 62, the transfer cylinder 70 transfers the toner images from the transfer belt 62 to the recording medium P while transporting the recording medium P.

### Fixing Device 15

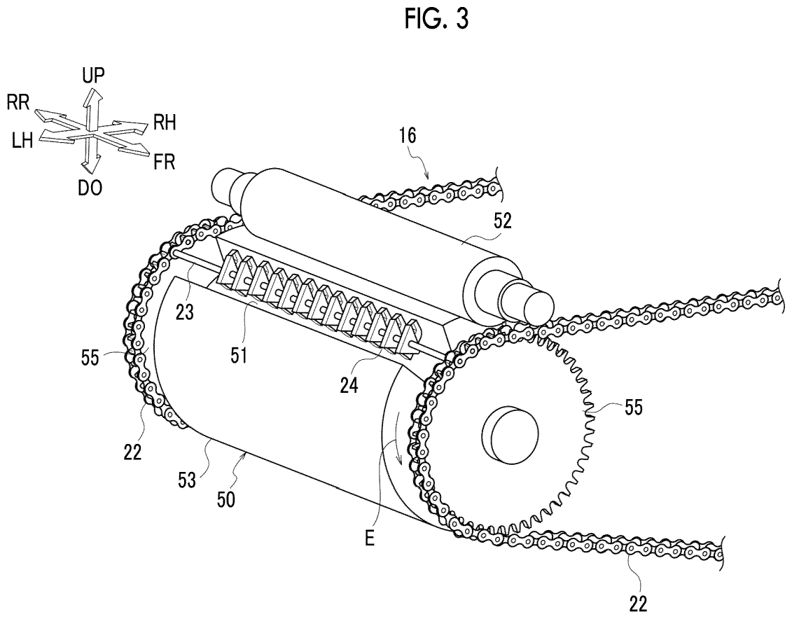

The fixing device 15 shown in FIG. 1 is a device that fixes, onto the recording medium P, the toner images that are transferred onto the recording medium P via the transfer cylinder 70. Specifically, as shown in FIGS. 1 and 3, the fixing device 15 includes a fixation cylinder 50 and a heating roll 52.

A recess portion 51 is formed at an outer peripheral surface of the fixation cylinder 50 (specifically, a cylinder body 53 which will be described later) and the fixation cylinder 50 rotates in a rotation direction E (a direction along an arrow E). The recess portion 51 is long in an axial direction of the fixation cylinder 50 and has a depth along a radial direction of the fixation cylinder 50.

As shown in FIG. 3, a pair of sprockets 55 is provided on both of axial end sides of the fixation cylinder 50. Specifically, the fixation cylinder 50 is configured to include the cylinder body 53 having an approximately cylindrical shape and the sprockets 55 provided on both of axial end sides with respect to the cylinder body 53. The pair of sprockets 55 is disposed to be coaxial with the cylinder body 53. In addition, in the fixation cylinder 50, the cylinder body 53 and the pair of sprockets 55 rotate integrally with each other in the rotation direction E as the cylinder body 53 rotates in the rotation direction E by being rotationally driven by a drive unit (not shown).

The heating roll 52 is disposed above the fixation cylinder 50. The heating roll 52 includes a heating source 52A (refer to FIG. 1) such as a halogen lamp inside the roll. Furthermore, the heating roll 52 rotates in a rotation direction F (a direction along an arrow F) which is a direction opposite to the rotation direction E.

Then, at the fixing device 15, the heating roll 52 and the fixation cylinder 50 transport the recording medium P transported by the transport mechanism 16 (specifically, the grippers 24 which will be described later) by rotating in a state where the recording medium P is sandwiched between the heating roll 52 and the fixation cylinder 50 at a fixation position NP. The, the heating roll 52 heats the recording medium P and the recording medium P is pressed by the heating roll 52 and the fixation cylinder 50, so that the toner images transferred onto the recording medium P are fixed onto the recording medium P.

### Transport Mechanism 16

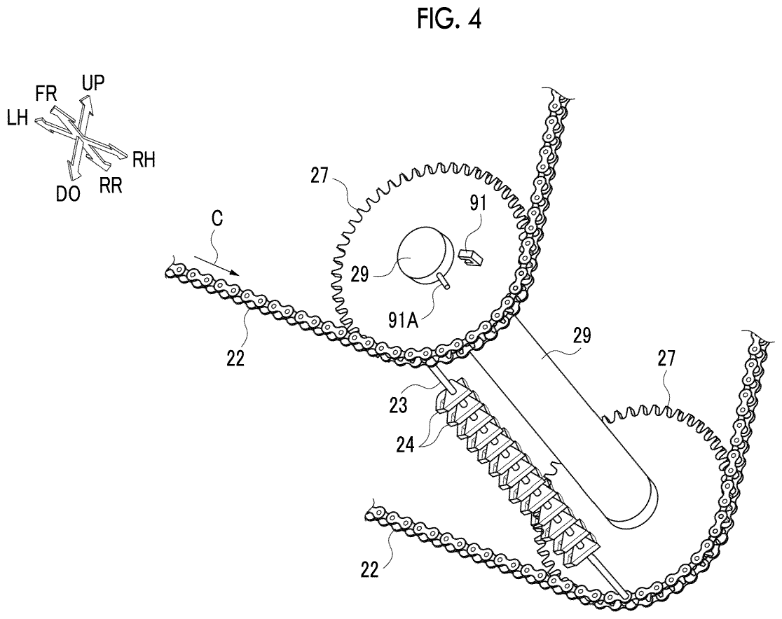

The transport mechanism 16 shown in FIG. 1 is a mechanism that transports the recording medium P. As shown in FIGS. 1 and 4, the transport mechanism 16 includes a pair of sprockets 27, a pair of chains 22, and the grippers 24. The grippers 24 are an example of holding units.

Note that in FIG. 1, one of the paired chains 22 and one of the paired sprockets 27 are shown and the chains 22, the sprockets 27, and the grippers 24 are shown in a simplified manner.

The pair of sprockets 27 is an example of a rotating body and is disposed below the pair of sprockets 75 and the pair of sprockets 55 and is disposed on a right side with respect to the pair of sprockets 55 (that is, on a side close to the pair of sprockets 75). As shown in FIG. 4, the paired sprockets 27 are disposed at an interval in the front-rear direction.

As shown in FIG. 1, each of the paired chains 22 is formed in an annular shape. As shown in FIG. 4, the paired chains 22 are disposed at an interval in the front-rear direction. The paired chains 22 are respectively wound around the paired sprockets 75 which are provided on both of the axial end sides of the transfer cylinder 70, are respectively wound around the paired sprockets 55 which are provided on both of the axial end sides of the fixation cylinder 50, and are respectively wound the paired sprockets 27. In addition, the chains 22 revolve in a revolution direction (a direction along an arrow C) as the transfer cylinder 70 is rotationally driven in the rotation direction B and the fixation cylinder 50 is rotationally driven in the rotation direction E. In this manner, the chains 22 function as revolving units that revolve in the revolution direction C. The transfer cylinder 70 and the fixation cylinder 50 are rotationally driven in synchronization with each other, and the pair of sprockets 27 rotates by being driven as the chains 22 revolve. Therefore, in the present exemplary embodiment, the pair of chains 22, the pair of sprockets 27, the transfer cylinder 70, and the fixation cylinder 50 rotate integrally with each other.

As shown in FIG. 4, attachment members 23 to which the grippers 24 are attached are suspended between the paired chains 22 along the front-rear direction. A plurality of the attachment members 23 are fixed to the pair of chains 22 at predetermined intervals in the revolution direction C of the chains 22.

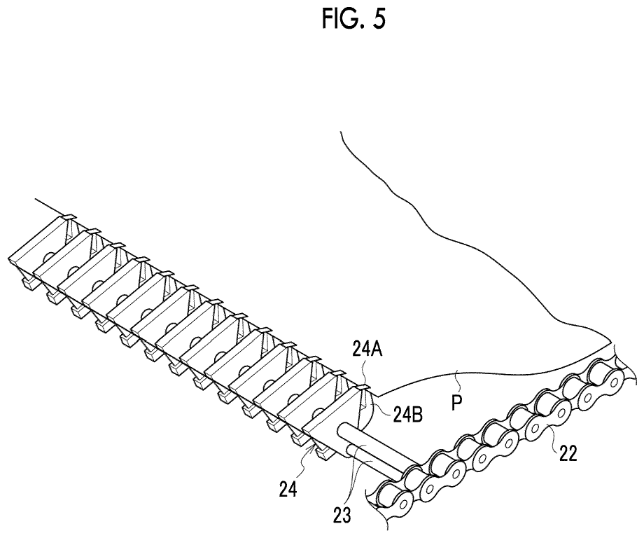

As shown in FIG. 4, a plurality of the grippers 24 are attached to each attachment member 23 at predetermined intervals in the front-rear direction. The grippers 24 function as holding units that hold a leading end portion of the recording medium P. Specifically, each gripper 24 includes a claw 24A and a claw base 24B as shown in FIG. 5. The gripper 24 is configured to hold the recording medium P with the leading end portion of the recording medium P being sandwiched between the claw 24A and the claw base 24B. Note that, regarding the gripper 24, for example, the claw 24A is pressed against the claw base 24B by a spring or the like and the claw 24A is opened or closed with respect to the claw base 24B by the action of a cam or the like.

In the transport mechanism 16, the leading end portion of the recording medium P that is fed from the medium accommodation portion 12 by the feeding unit 13 is held by the grippers 24 as shown in FIG. 5. In the present exemplary embodiment, the grippers 24 start to hold the recording medium P at a predetermined holding start position (for example, a position indicated by a reference numeral “SP” in FIG. 1).

Here, in the transport mechanism 16, for example, the circumferential length of the chains 22 is a natural number times the circumferential length of the sprockets 27. Furthermore, the attachment members 23 (that is, the grippers 24) are attached to the chains 22 at intervals each of which corresponds to the circumferential length of the sprockets 27, for example. Accordingly, each time the sprockets 27 make one complete rotation, the plurality of grippers 24 arrive at the holding start position sequentially and start to hold the recording medium P at the holding start position.

Furthermore, in the transport mechanism 16, as the chains 22 revolve in the revolution direction C, the grippers 24 holding the leading end portion of the recording medium P transport the recording medium P by integrally moving with rotational movement of the transfer cylinder 70, so that the recording medium P passes through the secondary transfer region T2. Then, at the secondary transfer region T2, the toner images that are primarily transferred onto the transfer belt 62 at the primary transfer regions T1 for the respective colors to be superimposed onto each other are secondarily transferred onto the recording medium P by the transfer cylinder 70 at the secondary transfer region T2.

Furthermore, as the chains 22 revolve in the revolution direction C, the grippers 24 holding the leading end portion of the recording medium P transport the recording medium P such that the recording medium P passes through the fixation position NP. Then, the fixing device 15 fixes an image on the recording medium P onto the recording medium with the recording medium P sandwiched between the heating roll 52 and the fixation cylinder 50 at the fixation position NP.

Note that in a case where the grippers 24 pass through the secondary transfer region T2, the grippers 24 and the attachment member 23 are accommodated in the recess portion 71 formed at the outer peripheral surface of the transfer cylinder 70 and thus contact between the grippers 24, the attachment member 23, and the transfer belt 62 does not occur. In addition, in a case where the grippers 24 pass through the fixation position NP, the grippers 24 and the attachment member 23 are accommodated in the recess portion 51 formed at the outer peripheral surface of the fixation cylinder 50 and thus contact between the grippers 24, the attachment member 23, and the heating roll 52 does not occur.

In addition, the pair of sprockets 75 provided on both of the axial end sides of the transfer cylinder 70 and the pair of sprockets 55 provided on both of the axial end sides of the fixation cylinder 50 can be grasped as constituent elements of the transport mechanism 16.

### First Rotation Position Sensor 91

The first rotation position sensor 91 shown in FIG. 4 is a constituent unit that detects a predetermined rotation position (hereinafter, referred to as a first reference rotation position) of the sprocket 27. That is, the first rotation position sensor 91 detects that the rotating sprocket 27 has arrived at the first reference rotation position (in other words, a predetermined rotation angle).

As the first rotation position sensor 91, for example, a photosensor that detects passage of an actuator 91A attached to a rotary shaft 29 of the sprocket 27 can be used (refer to FIG. 4).

Here, in the present exemplary embodiment, an arrival timing (in other words, a holding start timing at which the grippers 24 start to hold the recording medium P) at which each of the grippers 24, which arrive at the holding start position each time the sprockets 27 make a complete rotation, arrives at the holding start position and an arrival timing (that is, a detection timing at which detection of the first reference rotation position is performed by the first rotation position sensor 91) at which the sprockets 27 arrive at the first reference rotation position are synchronized with each other.

Furthermore, a feeding timing at which the feeding unit 13 performs feeding is based on the detection timing at which the first rotation position sensor 91 performs detection. In the present exemplary embodiment, as will be described later, the feeding unit 13 feeds the recording medium P toward the grippers 24 based on the detection timing at which the first reference rotation position is detected by the first rotation position sensor 91. Accordingly, the recording medium P arrives at the holding start position in accordance with the arrival timing (in other words, a holding start timing at which the grippers 24 start to hold the recording medium P) at which the grippers 24 arrive at the holding start position.

Note that detection information (that is, a detection signal) about detection of a reference rotation position that is performed by the first rotation position sensor 91 is transmitted to the control device 40. In addition, rotation performed for a period of time between when the first rotation position sensor 91 detects the first reference rotation position once and when the first rotation position sensor 91 detects the first reference rotation position again is one complete rotation of the sprockets 27.

### Second Rotation Position Sensor 92

The second rotation position sensor 92 shown in FIG. 2 is an example of a detection unit and is a constituent unit that detects a predetermined rotation position (hereinafter, referred to as a second reference rotation position) of the transfer cylinder 70. That is, the second rotation position sensor 92 detects that the rotating transfer cylinder 70 has arrived at the second reference rotation position (in other words, a predetermined rotation angle).

As the second rotation position sensor 92, for example, a photosensor that detects passage of an actuator 92A attached to a rotary shaft 73 of the transfer cylinder 70 can be used (refer to FIG. 2).

Here, in the present exemplary embodiment, the second reference rotation position detected by the second rotation position sensor 92 and a position (hereinafter, will be referred to as a secondary transfer start position) where second transfer to the recording medium P transported by the transport mechanism 16 (specifically, the grippers 24) in a state of being disposed on the outer peripheral surface 70A of the transfer cylinder 70 is started coincide with each other.

Therefore, a detection timing at which the second rotation position sensor 92 detects the second reference rotation position and a secondary transfer start timing at which second transfer to the recording medium P transported by the transport mechanism 16 (specifically, the grippers 24) in a state of being disposed on the outer peripheral surface 70A of the transfer cylinder 70 is started are synchronized with each other. Note that it can be said that the secondary transfer start timing is a timing at which the recording medium P (specifically, a leading end of a transfer region of the recording medium P) arrives at the secondary transfer start position. The secondary transfer start timing is an example of a transfer start timing.

Specifically, the secondary transfer start position is a position where a leading end (a downstream end in a transport direction) of an image region of the recording medium P in a state of being disposed on the outer peripheral surface 70A of the transfer cylinder 70 starts to be introduced into the secondary transfer region T2. For example, the secondary transfer start position is a position (a position facing the facing roll 65) where an upstream end 71X (refer to FIG. 2) of the recess portion 71 of the transfer cylinder 70 in a rotation direction starts to be introduced into the secondary transfer region T2.

Furthermore, a writing timing at which the exposure devices 36 perform writing is based on the detection timing at which the second rotation position sensor 92 performs detection. In the present exemplary embodiment, as will be described later, the exposure devices 36 write electrostatic latent images on the photoreceptors 32 based on the detection timing at which the second reference rotation position is detected by the second rotation position sensor 92.

Note that detection information (that is, a detection signal) about detection of a reference rotation position that is performed by the second rotation position sensor 92 is transmitted to the control device 40. In addition, rotation performed for a period of time between when the second rotation position sensor 92 detects the second reference rotation position once and when the second rotation position sensor 92 detects the second reference rotation position again is one complete rotation of the transfer cylinder 70.

### Control Device 40

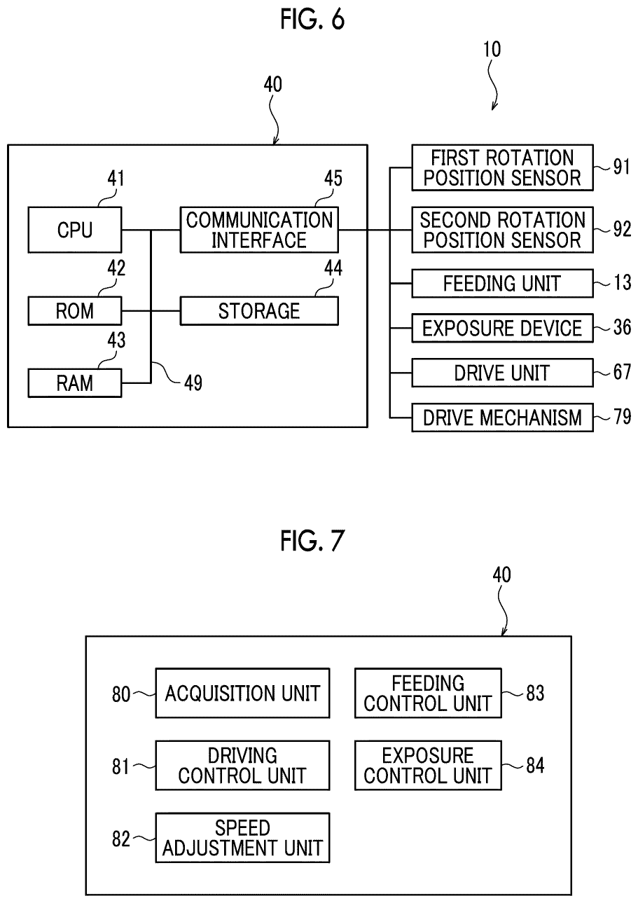

As shown in FIG. 6, the control device 40 is an example of a speed adjustment mechanism and includes a central processing unit (CPU) 41, a read only memory (ROM) 42, a random access memory (RAM) 43, a storage 44, and a communication interface (I/F) 45. In addition, the components are communicably connected to each other via a bus 49. Note that the CPU 41 (specifically, a speed adjustment unit 82 which will be described later) may be grasped as an example of the speed adjustment mechanism.

The CPU 41 is a central processing unit, and executes various programs or controls each unit. The ROM 42 stores various programs including a control program and various data. The RAM 43 temporarily stores programs or data as a work area. The storage 44 is configured by a storage medium such as a hard disk drive (HDD), a solid state drive (SSD), or a flash memory and stores various programs including an operating system and various data. Note that the control program may be stored in the storage 44.

The communication interface 45 is an interface for communication with other constituent units such as the image forming unit 14 including the exposure devices 36, the feeding unit 13, the first rotation position sensor 91, the second rotation position sensor 92, the drive unit 67, and the drive mechanism 79. The communication interface 45 communicates with the other constituent units in a wired or wireless manner and by using communication means such as the Internet and an intranet.

In the control device 40, the CPU 41 reads various programs including the control program from the ROM 42 or from the storage 44 and executes the programs by using the RAM 43 as a work area. Then, the CPU 41 controls operations of each unit of the image forming apparatus 10 by executing the control program. Hereinafter, a functional configuration realized by cooperation between the CPU 41 as a hardware resource and an information processing program as a software resource will be described. FIG. 7 is a block diagram showing an example of the functional configuration of the control device 40 according to the present exemplary embodiment.

Note that the control device 40 may be configured as a speed adjustment device specialized for adjustment of the rotation speed of the transfer cylinder 70.

In the control device 40, the CPU 41 executes the control program to function as an acquisition unit 80, a driving control unit 81, the speed adjustment unit 82, a feeding control unit 83, and an exposure control unit 84 as shown in FIG. 7.

Note that the acquisition unit 80 acquires, from the first rotation position sensor 91, detection information (that is, a detection signal) about detection of the first reference rotation position that is performed by the first rotation position sensor 91. In addition, the acquisition unit 80 acquires, from the second rotation position sensor 92, detection information (that is, a detection signal) about detection of the second reference rotation position that is performed by the second rotation position sensor 92.

The feeding control unit 83 controls the feeding unit 13 to cause the feeding unit 13 to feed the recording medium P toward the grippers 24 based on the detection timing, at which the first reference rotation position is detected by the first rotation position sensor 91, such that the recording medium P arrives at the holding start position at the arrival timing (in other words, the holding start timing at which the grippers 24 start to hold the recording medium P) at which the grippers 24 arrive at the holding start position.

Note that, the feeding speed (the transportation speed) of the feeding unit 13 and the length of a path from the feeding unit 13 to the holding start position may be set such that the arrival timing (in other words, the holding start timing at which the grippers 24 start to hold the recording medium P) at which the grippers 24 arrive at the holding start position and the arrival timing at which the recording medium P arrives at the holding start position are synchronized with each other in a case where the feeding unit 13 feeds the recording medium P at the detection timing of the first rotation position sensor 91. In such a case, the feeding control unit 83 controls the feeding unit 13 to cause the feeding unit 13 to feed the recording medium P at the detection timing at which the first rotation position sensor 91 performs detection.

The exposure control unit 84 controls the exposure device 36 to cause the exposure device 36 to write an electrostatic latent image on the photoreceptor 32 based on the detection timing, at which the second reference rotation position is detected by the second rotation position sensor 92, such that a timing at which toner images transferred onto the transfer belt 62 from the photoreceptors 32 arrive at the secondary transfer start position and the secondary transfer start timing (specifically, a timing at which the recording medium P arrives at the secondary transfer start position) are synchronized with each other.

Note that the exposure device 36 to be controlled is the exposure device 36 of one (for example, the toner image forming unit 30 (Y) disposed on the most upstream side) of the plurality of the toner image forming units 30 (for example, the toner image forming units 30 (Y), 30 (M), 30 (C), and 30 (K)) of which the exposure device 36 operates first. In the present exemplary embodiment, after the exposure device 36 of which the writing timing is controlled performs writing at the toner image forming unit, the exposure devices 36 of the other toner image forming units perform writing sequentially. Then, after the developing step is executed at each of the toner image forming units, toner images are transferred to the transfer belt 62.

The driving control unit 81 is a functional unit that controls the driving of the drive unit 67 which rotationally drives the driving roll 64D. The driving control unit 81 generates, for example, a pulse signal, and controls the driving of the drive unit 67 by means of the pulse signal. Note that as the drive unit 67, for example, a servo motor or a stepping motor is used.

The speed adjustment unit 82 is a functional unit that adjusts the speed of the transfer cylinder 70 by controlling the driving of the drive mechanism 79 which rotationally drives the transfer cylinder 70. The speed adjustment unit 82 generates, for example, a pulse signal, and controls the driving of the drive mechanism 79 by means of the pulse signal. Note that as the drive mechanism 79, for example, a servo motor or a stepping motor is used.

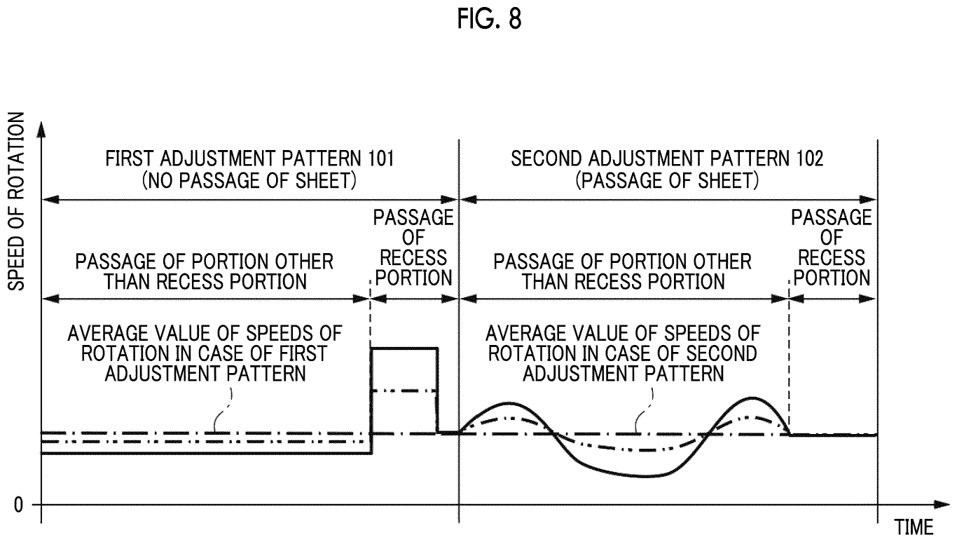

The speed adjustment unit 82 adjusts, each time the transfer cylinder 70 makes one rotation, the rotation speed of the transfer cylinder 70 rotated by the drive mechanism 79. Specifically, the speed adjustment unit 82 switches between a first adjustment pattern 101 (refer to FIG. 8) and a second adjustment pattern 102 (refer to FIG. 8), in which the speed profile is different from the first adjustment pattern 101, each time the transfer cylinder 70 makes one rotation.

Here, a load (rotational resistance) acting on the transfer belt 62 may change depending on whether or not the transfer cylinder 70 and the transfer belt 62 are in contact with each other and whether or not the transfer cylinder 70 transports the recording medium P in a state where the transfer cylinder 70 and the transfer belt 62 are in contact with each other (in other words, whether or not the recording medium P passes through the secondary transfer region T2). In the present exemplary embodiment, a fluctuation (that is, a variation) in rotational torque at the driving roll 64D is suppressed since a switch between the first adjustment pattern 101 (refer to FIG. 8) and the second adjustment pattern 102 (refer to FIG. 8) set as follows is performed each time the transfer cylinder 70 makes one rotation.

The first adjustment pattern 101 is a pattern for adjustment of the rotation speed of the transfer cylinder 70 in the case of a revolution including a state where the transfer cylinder 70 does not transport the recording medium P. The second adjustment pattern 102 is a pattern for adjustment of the rotation speed of the transfer cylinder 70 in the case of a revolution including a state where the transfer cylinder 70 transports the recording medium P.

A time for which the first adjustment pattern 101 continues and a time for which the second adjustment pattern 102 continues coincide with a time for which the transfer cylinder 70 makes one rotation, and the average value of the speeds of rotation in the case of the first adjustment pattern 101 and the average value of the speeds of rotation in the case of the second adjustment pattern 102 coincide with each other.

In the present exemplary embodiment, the second adjustment pattern 102 is different from the first adjustment pattern 101 in average value of the speeds of rotation of the transfer cylinder 70 that is made in a state where a portion of the transfer cylinder 70 other than the recess portion 71 passes through the secondary transfer region T2. In the present exemplary embodiment, the second adjustment pattern 102 is higher than the first adjustment pattern 101 in average value of the speeds of rotation of the transfer cylinder 70 that is made in a state where a portion of the transfer cylinder 70 other than the recess portion 71 passes through the secondary transfer region T2.

In addition, in the present exemplary embodiment, for example, the second adjustment pattern 102 is lower than the first adjustment pattern 101 in average value of the speeds of rotation of the transfer cylinder 70 that is made in a state where the recess portion 71 of the transfer cylinder 70 passes through the secondary transfer region T2.

In addition, regarding the first adjustment pattern 101, for example, the average value of the speeds of rotation of the transfer cylinder 70 that is made in a state where the recess portion 71 of the transfer cylinder 70 passes through the secondary transfer region T2 is higher than the average value of the speeds of rotation of the transfer cylinder 70 that is made in a state where a portion of the transfer cylinder 70 other than the recess portion 71 passes through the secondary transfer region T2.

Note that switching between the adjustment patterns is performed in accordance with the state of transportation of the recording medium P that is performed by the transport mechanism 16 and is performed by switching from one of the first adjustment pattern 101 and the second adjustment pattern 102 to the other of the first adjustment pattern 101 and the second adjustment pattern 102 after the one of the first adjustment pattern 101 and the second adjustment pattern 102 is executed once or a plurality of times.

### Actions of First Adjustment Pattern 101 and Second Adjustment Pattern 102

In the present exemplary embodiment, as described above, the first adjustment pattern 101 is a pattern for adjustment of the rotation speed of the transfer cylinder 70 in the case of a revolution including a state where the transfer cylinder 70 does not transport the recording medium P and the second adjustment pattern 102 is a pattern for adjustment of the rotation speed of the transfer cylinder 70 in the case of a revolution including a state where the transfer cylinder 70 transports the recording medium P.

Therefore, the rotation speed of the transfer cylinder 70 may be adjusted to a rotation speed appropriate for a state where the transfer cylinder 70 transports the recording medium P and a rotation speed appropriate for a state where the transfer cylinder 70 does not transport the recording medium P in comparison with a case where the first adjustment pattern 101 and the second adjustment pattern 102 are patterns for adjustment of the rotation speed of the transfer cylinder 70 in the case of a revolution including a state where the transfer cylinder 70 transports the recording medium P.

Furthermore, in the present exemplary embodiment, the second adjustment pattern 102 is higher than the first adjustment pattern 101 in average value of the speeds of rotation of the transfer cylinder 70 that is made in a state where a portion of the transfer cylinder 70 other than the recess portion 71 passes through the secondary transfer region T2.

Here, a load that acts on the transfer belt 62 in a case where the recording medium P passes through the secondary transfer region T2 may be larger than a load that acts on the transfer belt 62 in a case where the recording medium P does not pass through the secondary transfer region T2. In such a case, the load acting on the transfer belt 62 is reduced in a case where the average value in the case of the second adjustment pattern 102 is made high.

Therefore, a torque fluctuation of the driving roll 64D may be reduced in comparison with a case where the second adjustment pattern 102 is equal to the first adjustment pattern 101 in average value of the speeds of rotation of the transfer cylinder 70 that is made in a state where a portion of the transfer cylinder 70 other than the recess portion 71 passes through the secondary transfer region T2.

In addition, in the present exemplary embodiment, the second adjustment pattern 102 is lower than the first adjustment pattern 101 in average value of the speeds of rotation of the transfer cylinder 70 that is made in a state where the recess portion 71 of the transfer cylinder 70 passes through the secondary transfer region T2.

Here, as described above, in the present exemplary embodiment, the second adjustment pattern 102 is higher than the first adjustment pattern 101 in average value of the speeds of rotation of the transfer cylinder 70 that is made in a state where a portion of the transfer cylinder 70 other than the recess portion 71 passes through the secondary transfer region T2. Therefore, a difference between the average value of the speeds of rotation of the transfer cylinder 70 throughout the first adjustment pattern 101 and the average value of the speeds of rotation of the transfer cylinder 70 throughout the second adjustment pattern 102 is made small in comparison with a case where the second adjustment pattern 102 is equal to the first adjustment pattern 101 in average value of the speeds of rotation of the transfer cylinder 70 that is made in a state where the recess portion 71 of the transfer cylinder 70 passes through the secondary transfer region T2. In other words, the average value of the speeds of rotation of the transfer cylinder 70 throughout the first adjustment pattern 101 and the average value of the speeds of rotation of the transfer cylinder 70 throughout the second adjustment pattern 102 can be made coincide with each other.

Synchronization with Switching Timing in Speed Adjustment Unit 82

The speed adjustment unit 82 synchronizes the timing of a switch between the first adjustment pattern 101 and the second adjustment pattern 102 (hereinafter, referred to as a switching timing) with the detection timing at which the second rotation position sensor 92 detects the second reference rotation position. The detection timing is synchronized with the transfer start timing at which the transfer cylinder 70 starts to transfer, to the recording medium P, the toner images transferred onto the transfer belt 62. Therefore, the speed adjustment unit 82 synchronizes the switching timing with the transfer start timing at which the transfer cylinder 70 starts to transfer, to the recording medium P, the toner images transferred onto the transfer belt 62.

In addition, the speed adjustment unit 82 synchronizes the switching timing with the detection timing at which the first rotation position sensor 91 detects the first reference rotation position. The detection timing is synchronized with the arrival timing (in other words, the holding start timing at which the grippers 24 start to hold the recording medium P) at which the grippers 24 arrive at the holding start position. Therefore, the speed adjustment unit 82 synchronizes the switching timing with the holding start timing at which the grippers 24 start to hold the recording medium P.

Action of Synchronization with Switching Timing in Speed Adjustment Unit 82

In the present exemplary embodiment, the speed adjustment unit 82 synchronizes the switching timing, at which a switch between the first adjustment pattern 101 and the second adjustment pattern 102 is made, with the holding start timing at which the grippers 24 start to hold the recording medium P.

Here, in a case (hereinafter, will be referred to as a case A) where the speed adjustment unit 82 switches between the first adjustment pattern 101 and the second adjustment pattern 102 regardless of the holding start timing at which the grippers 24 start to hold the recording medium P, a holding position where the grippers 24 hold the recording medium P may vary and there may be a change in room for a grip (that is, a margin on a leading end side of the recording medium P) since the speed profiles of the first adjustment pattern 101 and the second adjustment pattern 102 are different from each other. As a result, a transfer position where an image is transferred onto the recording medium P may vary.

However, in the present exemplary embodiment, as described above, the speed adjustment unit 82 synchronizes the switching timing, at which a switch between the first adjustment pattern 101 and the second adjustment pattern 102 is made, with the holding start timing at which the grippers 24 start to hold the recording medium P. Therefore, in comparison with the case A, a variation in holding position where the grippers 24 hold the recording medium P is suppressed even in a case where the adjustment pattern is switched between the first adjustment pattern 101 and the second adjustment pattern 102. As a result, a variation in transfer position where an image is transferred onto the recording medium Pis suppressed.

In addition, in the present exemplary embodiment, the speed adjustment unit 82 synchronizes the switching timing, at which a switch between the first adjustment pattern 101 and the second adjustment pattern 102 is made, with the detection timing at which the first rotation position sensor 91 detects the first reference rotation position.

Here, the feeding unit 13 feeds the recording medium P toward the grippers 24 (specifically, the holding start position) based on the detection timing and thus in a case (hereinafter, will be referred to as a case B) where the speed adjustment unit 82 switches between the first adjustment pattern 101 and the second adjustment pattern 102 regardless of the detection timing, a holding position where the grippers 24 hold the recording medium P may vary and there may be a change in room for a grip (that is, a margin on the leading end side of the recording medium P) since the speed profiles of the first adjustment pattern 101 and the second adjustment pattern 102 are different from each other. As a result, a position where an image is transferred onto the recording medium P may vary.

However, in the present exemplary embodiment, as described above, the speed adjustment unit 82 synchronizes the switching timing, at which a switch between the first adjustment pattern 101 and the second adjustment pattern 102 is made, with the detection timing at which the first rotation position sensor 91 detects the first reference rotation position. Therefore, in comparison with the case B, a variation in holding position where the grippers 24 hold the recording medium P is suppressed even in a case where the adjustment pattern is switched between the first adjustment pattern 101 and the second adjustment pattern 102. As a result, a variation in transfer position where an image is transferred onto the recording medium P is suppressed.

In addition, in the present exemplary embodiment, the speed adjustment unit 82 synchronizes the switching timing, at which a switch between the first adjustment pattern 101 and the second adjustment pattern 102 is made, with the detection timing at which the second rotation position sensor 92 detects the second reference rotation position.

Here, in a case (hereinafter, will be referred to as a case C) where the speed adjustment unit 82 switches between the first adjustment pattern 101 and the second adjustment pattern 102 regardless of the detection timing, a writing timing at which the exposure devices 36 perform writing may vary and a transfer position where an image is transferred onto the recording medium P may vary since the speed profiles of the first adjustment pattern 101 and the second adjustment pattern 102 are different from each other.

However, in the present exemplary embodiment, as described above, the speed adjustment unit 82 synchronizes the switching timing, at which a switch between the first adjustment pattern 101 and the second adjustment pattern 102 is made, with the detection timing at which the second rotation position sensor 92 detects the second reference rotation position. Therefore, in comparison with the case C, a variation in writing timing is suppressed and a variation in transfer position where an image is transferred onto the recording medium P is suppressed even in a case where the adjustment pattern is switched between the first adjustment pattern 101 and the second adjustment pattern 102.

In addition, in the present exemplary embodiment, the speed adjustment unit 82 synchronizes the switching timing, at which a switch between the first adjustment pattern 101 and the second adjustment pattern 102 is made, with the secondary transfer start timing at which the transfer cylinder 70 starts to transfer, to the recording medium P, the toner images transferred onto the transfer belt 62.

Here, in a case (hereinafter, will be referred to as a case D) where the speed adjustment unit 82 switches between the first adjustment pattern 101 and the second adjustment pattern 102 regardless of the transfer start timing, the transfer start timing may vary and a transfer position where an image is transferred onto the recording medium P may vary since the speed profiles of the first adjustment pattern 101 and the second adjustment pattern 102 are different from each other.

However, in the present exemplary embodiment, as described above, the speed adjustment unit 82 synchronizes the switching timing, at which a switch between the first adjustment pattern 101 and the second adjustment pattern 102 is made, with the transfer start timing at which the transfer cylinder 70 starts to transfer, to the recording medium P, the toner images transferred onto the transfer belt 62. Therefore, in comparison with the case D, a variation in transfer start timing is suppressed and a variation in transfer position where an image is transferred onto the recording medium P is suppressed even in a case where the adjustment pattern is switched between the first adjustment pattern 101 and the second adjustment pattern 102.

### Profile Change in Speed Adjustment Unit 82

Furthermore, the speed adjustment unit 82 can change, during a revolution of the transfer belt 62, a speed profile in each of the first adjustment pattern 101 and the second adjustment pattern 102 while maintaining the average value of the speeds of rotation of the transfer cylinder 70, as represented by two-dot chain lines in FIG. 8.

In a case where (hereinafter, will be referred to as a case where a profile change X1 is performed) the speed adjustment unit 82 changes, during a revolution of the transfer belt 62, a speed profile in each of the first adjustment pattern 101 and the second adjustment pattern 102 while maintaining the average value of the speeds of rotation of the transfer cylinder 70, the exposure control unit 84 controls the exposure device 36 to cause the exposure device 36 to write an electrostatic latent image on the photoreceptor 32 at the same writing timing as before the change. Accordingly, even in a case where the profile change X1 is performed, the exposure device 36 writes an electrostatic latent image on the photoreceptor 32 at the same writing timing as before the change.

In addition, in the present exemplary embodiment, in a case where the speed adjustment unit 82 performs the profile change X1, the transfer cylinder 70 starts to transfer, to the recording medium P, the toner images transferred onto the transfer belt 62 at the same start timing as before the change.

Furthermore, in the present exemplary embodiment, in a case where the speed adjustment unit 82 performs the profile change X1, the grippers 24 hold the recording medium P at the same holding start timing as before the change.

In addition, in the present exemplary embodiment, in a case where the speed adjustment unit 82 performs the profile change X1, the feeding control unit 83 controls the feeding unit 13 to cause the feeding unit 13 to feed the recording medium P at the same feeding timing as before the change. Accordingly, even in a case where the profile change X1 is performed, the feeding unit 13 feeds the recording medium P at the same feeding timing as before the change.

### Action of Profile Change in Speed Adjustment Unit 82

In the present exemplary embodiment, as described above, the speed adjustment unit 82 can change, during a revolution of the transfer belt 62, a speed profile in each of the first adjustment pattern 101 and the second adjustment pattern 102 while maintaining the average value of the speeds of rotation of the transfer cylinder 70, as represented by the two-dot chain lines in FIG. 8.

Accordingly, the speed of rotation of the transfer cylinder 70 in each of the first adjustment pattern 101 and the second adjustment pattern 102 may be changed in accordance with a torque fluctuation of the driving roll 64D during the revolution of the transfer belt 62.

Here, in the present exemplary embodiment, the switching timing at which a switch between the first adjustment pattern 101 and the second adjustment pattern 102 is made is synchronized with various timings (the detection timings at which detection is performed by the first rotation position sensor 91 and the second rotation position sensor 92, the holding start timing, and the secondary transfer start timing). Therefore, even in a case where there is a change in speed profile in each of the first adjustment pattern 101 and the second adjustment pattern 102, the various timings are unlikely to vary and a variation in transfer position where an image is transferred onto the recording medium P is suppressed.

In addition, in the present exemplary embodiment, in a case where the speed adjustment unit 82 performs the profile change X1, the exposure device 36 writes an electrostatic latent image on the photoreceptor 32 at the same writing timing as before the change. Therefore, it is not necessary to control the writing timing of the exposure device 36.

In addition, in the present exemplary embodiment, in a case where the speed adjustment unit 82 performs the profile change X1, the transfer cylinder 70 starts to transfer, to the recording medium P, the toner images transferred onto the transfer belt 62 at the same secondary transfer start timing as before the change. Therefore, it is not necessary to control the secondary transfer start timing of the transfer cylinder 70.

Furthermore, in the present exemplary embodiment, in a case where the speed adjustment unit 82 performs the profile change X1, the grippers 24 hold the recording medium P at the same holding start timing as before the change. Therefore, it is not necessary to control the holding start timing of the grippers 24.

In addition, in the present exemplary embodiment, in a case where the speed adjustment unit 82 performs the profile change X1, the feeding unit 13 feeds the recording medium P at the same feeding timing as before the change. Therefore, it is not necessary to control the feeding timing of the feeding unit 13.

### MODIFICATION EXAMPLES

In the present exemplary embodiment, the speed adjustment unit 82 synchronizes the switching timing, at which a switch between the first adjustment pattern 101 and the second adjustment pattern 102 is made, with the holding start timing at which the grippers 24 start to hold the recording medium P. However, the present invention is not limited thereto. For example, a configuration in which the speed adjustment unit 82 switches between the first adjustment pattern 101 and the second adjustment pattern 102 regardless of the holding start timing may also be adopted.

In addition, in the present exemplary embodiment, the speed adjustment unit 82 synchronizes the switching timing, at which a switch between the first adjustment pattern 101 and the second adjustment pattern 102 is made, with the detection timing at which the first rotation position sensor 91 detects the first reference rotation position. However, the present invention is not limited thereto. For example, a configuration in which the speed adjustment unit 82 switches between the first adjustment pattern 101 and the second adjustment pattern 102 regardless of the detection timing may also be adopted.

In addition, in the present exemplary embodiment, the speed adjustment unit 82 synchronizes the switching timing, at which a switch between the first adjustment pattern 101 and the second adjustment pattern 102 is made, with the secondary transfer start timing at which the transfer cylinder 70 starts to transfer, to the recording medium P, the toner images transferred onto the transfer belt 62. However, the present invention is not limited thereto. For example, a configuration in which the speed adjustment unit 82 switches between the first adjustment pattern 101 and the second adjustment pattern 102 regardless of the transfer start timing may also be adopted.

In addition, in the present exemplary embodiment, the first adjustment pattern 101 is a pattern for adjustment of the rotation speed of the transfer cylinder 70 in the case of a revolution including a state where the transfer cylinder 70 does not transport the recording medium P and the second adjustment pattern 102 is a pattern for adjustment of the rotation speed of the transfer cylinder 70 in the case of a revolution including a state where the transfer cylinder 70 transports the recording medium P. However, the present invention is not limited thereto. For example, the first adjustment pattern 101 and the second adjustment pattern 102 may be patterns for adjustment of the rotation speed of the transfer cylinder 70 in the case of a revolution including a state where the transfer cylinder 70 transports the recording medium P and the first adjustment pattern 101 and the second adjustment pattern 102 may be adjustment patterns composed of any speed profiles.

In addition, in the present exemplary embodiment, the second adjustment pattern 102 is higher than the first adjustment pattern 101 in average value of the speeds of rotation of the transfer cylinder 70 that is made in a state where a portion of the transfer cylinder 70 other than the recess portion 71 passes through the secondary transfer region T2. However, the present invention is not limited thereto. For example, the second adjustment pattern 102 may be equal to the first adjustment pattern 101 in average value of the speeds of rotation of the transfer cylinder 70 that is made in a state where a portion of the transfer cylinder 70 other than the recess portion 71 passes through the secondary transfer region T2. In addition, for example, the second adjustment pattern 102 may be lower than the first adjustment pattern 101 in average value of the speeds of rotation of the transfer cylinder 70 that is made in a state where a portion of the transfer cylinder 70 other than the recess portion 71 passes through the secondary transfer region T2. Here, a load that acts on the transfer belt 62 in a case where the recording medium P passes through the secondary transfer region T2 may be smaller than a load that acts on the transfer belt 62 in a case where the recording medium P does not pass through the secondary transfer region T2. In such a case, the load acting on the transfer belt 62 is reduced in a case where the average value in the case of the second adjustment pattern 102 is made low. Therefore, a torque fluctuation of the driving roll 64D may be reduced in comparison with a case where the second adjustment pattern 102 is equal to the first adjustment pattern 101 in average value of the speeds of rotation of the transfer cylinder 70 that is made in a state where a portion of the transfer cylinder 70 other than the recess portion 71 passes through the secondary transfer region T2.

In addition, in the present exemplary embodiment, the second adjustment pattern 102 is lower than the first adjustment pattern 101 in average value of the speeds of rotation of the transfer cylinder 70 that is made in a state where the recess portion 71 of the transfer cylinder 70 passes through the secondary transfer region T2. However, the present invention is not limited thereto. For example, the second adjustment pattern 102 may be equal to the first adjustment pattern 101 in average value of the speeds of rotation of the transfer cylinder 70 that is made in a state where the recess portion 71 of the transfer cylinder 70 passes through the secondary transfer region T2. In addition, for example, the second adjustment pattern 102 may be higher than the first adjustment pattern 101 in average value of the speeds of rotation of the transfer cylinder 70 that is made in a state where the recess portion 71 of the transfer cylinder 70 passes through the secondary transfer region T2.

At the first adjustment pattern 101, for example, the average value of the speeds of rotation of the transfer cylinder 70 that is made in a state where the recess portion 71 of the transfer cylinder 70 passes through the secondary transfer region T2 is higher than the average value of the speeds of rotation of the transfer cylinder 70 that is made in a state where a portion of the transfer cylinder 70 other than the recess portion 71 passes through the secondary transfer region T2. However, the present invention is not limited thereto. For example, at the first adjustment pattern 101, the average value of the speeds of rotation of the transfer cylinder 70 that is made in a state where the recess portion 71 of the transfer cylinder 70 passes through the secondary transfer region T2 may be equal to the average value of the speeds of rotation of the transfer cylinder 70 that is made in a state where a portion of the transfer cylinder 70 other than the recess portion 71 passes through the secondary transfer region T2. In addition, at the first adjustment pattern 101, the average value of the speeds of rotation of the transfer cylinder 70 that is made in a state where the recess portion 71 of the transfer cylinder 70 passes through the secondary transfer region T2 may be lower than the average value of the speeds of rotation of the transfer cylinder 70 that is made in a state where a portion of the transfer cylinder 70 other than the recess portion 71 passes through the secondary transfer region T2.

In addition, in the present exemplary embodiment, a speed profile in each of the first adjustment pattern 101 and the second adjustment pattern 102 can be changed during a revolution of the transfer belt 62 while the average value of the speeds of rotation of the transfer cylinder 70 is maintained. However, the present invention is not limited thereto. A configuration in which the speed profile in each of the first adjustment pattern 101 and the second adjustment pattern 102 is maintained at all times (that is, a configuration in which the speed profile cannot be changed) may also be adopted.

In addition, in the present exemplary embodiment, in a case where the profile change X1 is performed, the exposure device 36 writes an electrostatic latent image on the photoreceptor 32 at the same writing timing as before the change. However, the present invention is not limited thereto. For example, a configuration, in which the exposure device 36 writes an electrostatic latent image on the photoreceptor 32 at a different writing timing from a writing timing before the profile change X1 in a case where the profile change X1 is performed, may also be adopted. In addition, in the present exemplary embodiment, in a case where the profile change X1 is performed, the transfer cylinder 70 starts to transfer, to the recording medium P, the toner images transferred onto the transfer belt 62 at the same start timing as before the change. However, the present invention is not limited thereto. For example, a configuration, in which the transfer cylinder 70 starts to transfer, to the recording medium P, the toner images transferred onto the transfer belt 62 at a different start timing from a start timing before the profile change X1 in a case where the profile change X1 is performed, may also be adopted.

In addition, in the present exemplary embodiment, in a case where the profile change X1 is performed, the grippers 24 hold the recording medium P at the same holding start timing as before the change. However, the present invention is not limited thereto. For example, a configuration, in which the grippers 24 hold the recording medium P at a different holding start timing from a holding start timing before the profile change X1 in a case where the profile change X1 is performed, may also be adopted.

In addition, in the present exemplary embodiment, in a case where the profile change X1 is performed, the feeding unit 13 feeds the recording medium P at the same feeding timing as before the change. However, the present invention is not limited thereto. For example, a configuration, in which the feeding unit 13 feeds the recording medium P at a different feeding timing from a feeding timing before the profile change X1 in a case where the profile change X1 is performed, may also be adopted.

The present invention is not limited to the above-described exemplary embodiment, and various modifications, changes, and improvements can be made without departing from the scope of the present invention. For example, the above-described modification examples may be combined with each other as appropriate.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1))

An image forming apparatus comprising:
a formation body on which a latent image is developed so that an image is formed;
a transfer belt with an outer peripheral surface onto which the image formed on the formation body is transferred, the transfer belt having an annular shape;
a driving roll around which the transfer belt is wound and that causes the transfer belt to revolve;
a transfer body that transfers, at a transfer region between the transfer body and the transfer belt, the image from the transfer belt to a recording medium while transporting the recording medium;
a drive mechanism that rotationally drives the transfer body;
a detection unit that detects a predetermined rotation position of the transfer body;
a writing unit that writes the latent image on the formation body based on a detection timing at which the detection unit detects the rotation position; and
a speed adjustment mechanism that adjusts a rotation speed of the transfer body rotated by the drive mechanism each time the transfer body makes one rotation, that switches between a first adjustment pattern and a second adjustment pattern in which a speed profile is different from the first adjustment pattern each time the transfer body makes one rotation, and that synchronizes a switching timing, at which switching between the adjustment patterns is performed, with the detection timing.

(((2)))

The image forming apparatus according to (((1))),
wherein the speed adjustment mechanism synchronizes the switching timing with a transfer start timing at which the transfer body starts to transfer, to the recording medium, the image transferred onto the transfer belt.

(((3)))

The image forming apparatus according to (((1))) or (((2))),
wherein the first adjustment pattern is a pattern for adjustment of the rotation speed of the transfer body in a case of a revolution including a state where the transfer body does not transport the recording medium, and
the second adjustment pattern is a pattern for adjustment of the rotation speed of the transfer body in a case of a revolution including a state where the transfer body transports the recording medium.

(((4)))

The image forming apparatus according to (((3))), further comprising:
a holding unit that holds the recording medium and that causes the recording medium to pass through the transfer region,
wherein a recess portion into which the holding unit is accommodable is provided at an outer peripheral surface of the transfer body, and
the second adjustment pattern is different from the first adjustment pattern in average value of speeds of rotation of the transfer body that is made in a state where a portion of the transfer body other than the recess portion passes through the transfer region.

(((5)

The image forming apparatus according to any one of (((1))) to ((4))),
wherein the speed adjustment mechanism is able to change, during a revolution of the transfer belt, a speed profile in each of the first adjustment pattern and the second adjustment pattern while maintaining an average value of speeds of rotation of the transfer body.

(((6)))

The image forming apparatus according to (((5))),
wherein, in a case where the speed adjustment mechanism changes, during the revolution of the transfer belt, the speed profile in each of the first adjustment pattern and the second adjustment pattern while maintaining the average value of the speeds of rotation of the transfer body, the writing unit writes the latent image on the formation body at the same writing timing as before the change.

(((7)))

The image forming apparatus according to (((5) or (6)
wherein, in a case where the speed adjustment mechanism changes, during the revolution of the transfer belt, the speed profile in each of the first adjustment pattern and the second adjustment pattern while maintaining the average value of the speeds of rotation of the transfer body, the transfer body starts to transfer, to the recording medium, the image transferred onto the transfer belt at the same transfer start timing as before the change.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a formation body on which a latent image is developed so that an image is formed;
a transfer belt with an outer peripheral surface onto which the image formed on the formation body is transferred, the transfer belt having an annular shape;
a driving roll around which the transfer belt is wound and that causes the transfer belt to revolve;
a transfer body that transfers, at a transfer region between the transfer body and the transfer belt, the image from the transfer belt to a recording medium while transporting the recording medium;
a drive mechanism that rotationally drives the transfer body;
a detection unit that detects a predetermined rotation position of the transfer body;
a writing unit that writes the latent image on the formation body based on a detection timing at which the detection unit detects the rotation position; and
a speed adjustment mechanism that adjusts a rotation speed of the transfer body rotated by the drive mechanism each time the transfer body makes one rotation, that switches between a first adjustment pattern and a second adjustment pattern in which a speed profile is different from the first adjustment pattern each time the transfer body makes one rotation, and that synchronizes a switching timing, at which switching between the adjustment patterns is performed, with the detection timing.

2. The image forming apparatus according to claim 1,
wherein the speed adjustment mechanism synchronizes the switching timing with a transfer start timing at which the transfer body starts to transfer, to the recording medium, the image transferred onto the transfer belt.

3. The image forming apparatus according to claim 1,
wherein the first adjustment pattern is a pattern for adjustment of the rotation speed of the transfer body in a case of a revolution including a state where the transfer body does not transport the recording medium, and
the second adjustment pattern is a pattern for adjustment of the rotation speed of the transfer body in a case of a revolution including a state where the transfer body transports the recording medium.

4. The image forming apparatus according to claim 3, further comprising:
a holding unit that holds the recording medium and that causes the recording medium to pass through the transfer region,
wherein a recess portion into which the holding unit is accommodable is provided at an outer peripheral surface of the transfer body, and
the second adjustment pattern is different from the first adjustment pattern in average value of speeds of rotation of the transfer body that is made in a state where a portion of the transfer body other than the recess portion passes through the transfer region.

5. The image forming apparatus according to claim 1,
wherein the speed adjustment mechanism is able to change, during a revolution of the transfer belt, a speed profile in each of the first adjustment pattern and the second adjustment pattern while maintaining an average value of speeds of rotation of the transfer body.

6. The image forming apparatus according to claim 5,
wherein, in a case where the speed adjustment mechanism changes, during the revolution of the transfer belt, the speed profile in each of the first adjustment pattern and the second adjustment pattern while maintaining the average value of the speeds of rotation of the transfer body, the writing unit writes the latent image on the formation body at the same writing timing as before the change.

7. The image forming apparatus according to claim 5,
wherein, in a case where the speed adjustment mechanism changes, during the revolution of the transfer belt, the speed profile in each of the first adjustment pattern and the second adjustment pattern while maintaining the average value of the speeds of rotation of the transfer body, the transfer body starts to transfer, to the recording medium, the image transferred onto the transfer belt at the same transfer start timing as before the change.
